(19) United States
(12) Patent Application Publication
(10) Pub. No.: US 2003/0005128 A1
(43) Pub. Date: Jan. 2, 2003

(54) Service access system

(76) Inventors: Andrew J. Hickman, London (GB); Marijan Leban, Ljubljana (SI)

Correspondence Address: Corporate Patent Counsel, U. S. Philips Corporation, 580 White Plains Road, Tarrytown, NY, 10591, US

(21) Appl. No.: 10/124,013

(22) Filed: Apr. 17, 2002

(30) Foreign Application Priority Data
Apr. 20, 2001 (GB) 0109726.0

(51) Int. Cl. G06F 15/16

(52) U.S. Cl. 709/227

(57) ABSTRACT

A service access system for accessing a remote service (10, 20, 40) from a computer system (50-90) is described. The service access system comprises a text file including a network address of the remote service and text data for use in formulating communications. An interpretation system at the computer system uses the text file to generate a user interface and formulate communications to the remote service.

The present invention relates to a service access system enabling a computer device to access services that it has no knowledge of at the time of production.

Communication between computer-based systems is commonly in the form of instructions. In order for one computer system to communicate with another, it is necessary that the first computer system understands the instruction set and semantics of the second computer system so that it can formulate instructions the second computer system can process. In order to achieve this, shared programming languages and standardized communication protocols have been developed to enforce a common link between instruction sets.

One type of instruction set that is being used with increasing popularity is referred to as metadata. Metadata, data about data, is normally a series of field names and corresponding values that describe attributes of a user, a computer system or an accompanying data item. Typically, a mark up language such as the extended mark up language (XML) is used. However, it is not possible to make assumptions about the structure and representations of metadata. Although all metadata may consist of field names and values marked up with XML, the same metadata is often represented completely differently in two similar systems. For example, metadata is increasingly being used to describe multimedia content for supply to users. In addition to a digital television broadcast, a set-top-box may receive a metadata file that includes fields describing the author, title, genre, duration and other attributes of the television broadcast. Such data is then used to generate a program guide of other information on the broadcast.

However, a computer system can only access and use point to point services it knows to exist. Such knowledge is pre-programmed at the time of production of the device. The pre-programmed knowledge is called upon when the user requests a corresponding function and is used to access the service. For example, the pre-programmed knowledge may include a network address to access the service and details on how to formulate queries or instructions.

Where a user's computer system has no pre-programmed knowledge of a service, it obviously cannot access the service as it does not know how to formulate queries or instructions or where to direct them once formulated. In the case of personal computers accessing services via the World Wide Web, a user can guide a personal computer to a Web site corresponding to the service and access the service via an interface provided on a page of the Web site. Should the service be changed or updated, the service provider can update the Web site to reflect this without affecting the user's computer system.

However, not all computer devices have the flexibility of personal computers. In particular, the new generation of mobile and intelligent devices such as mobile telephones, intelligent video recorders, set-top-boxes, intelligent household devices such as fridges and microwaves, and other CE devices are manufactured with embedded systems for accessing remote services or databases. For such devices there can be no expectation that the user is computer-literate, so they must not be required to enter configuration information themselves. Such embedded systems are written for the specific task of accessing the remote service or database and have a pre-written user interface designed for the specific purpose of providing access to the system. For example, an intelligent video recorder or a set-top-box may include an embedded system to obtain television schedule information from a remote source. Whilst such information may be obtained from a Web site, it quite likely that the device accesses a specifically designed database for the information to avoid the overheads associated with running a Web browser and accessing the Internet. Indeed, access may not even be over the internet but may be via another communication network such as a PSTN, a broadband network or a television network.

The manufacturers of such devices wish to offer access to services such as the television listings for televisions or video recorders, or recipes and food information for intelligent fridges and microwaves. However, both users and manufacturers wish such access to be seamless and do not wish the user to have to surf for the information via a Web browser or even know that they are accessing the Internet or other remote network. Ideally, the information or service should just appear to the user to be there at the device.

This aim is achieved due to the embedded nature of the systems used in the devices. The embedded system automatically accesses a remote data source or service, the capabilities and location of which were written within the embedded system during manufacture. The device knows exactly how and where to obtain the data or request a service and has the necessary programming to display any data returned.

Whilst such an embedded system means that the device does not need a generic browser, the resources to support such a browser and a user able to navigate the World Wide Web and use the browser, it does limit the extent to which the service can be extended or changed. For example, the service provider cannot change the network location of the service or data source and it must ensure that any changes are backwardly compatible.

According to a first aspect of the present invention, there is provided a system for accessing a remote service from a computer system comprising a text file of data on the remote service comprising a network address for communicating with the remote service and text data for formulating communications with the service, wherein the computer system includes an interpretation system for processing the text file, the interpretation system formulating communications to the network address of the remote service in dependence on the text data for formulating communications with the service.

By defining services in terms of a metadata file instead of providing a client software or embedded application, a user terminal can be much more flexible in the manner in which it accesses services. In particular, if the service changes or new services become available, the metadata file only needs to be updated instead of requiring new client software (which is often impossible and requires a new user terminal). Furthermore, the structure of the metadata file means that it is not tied to a particular platform, operating system or service. The same metadata file can be provided to different platforms, each of which can implement a user interface or client application in their own way. The use of a version identifier in the client-server communications allows services to be changed at the server and the client to automatically determine that and download a replacement metadata file that allows the client to take advantage of the changes, possibly by modifying the user interface or client application using the new file.

The interpretation system may be arranged to generate a user interface for display on the computer system in dependence on the text data for formulating communications, the computer system being arranged to accept inputs to the user interface, the interpretation system using the inputs to formulate the communications.

The text file and data received from the remote service may each include a version indicator, wherein the computer system is arranged to compare the version indicator of data received from the remote service with that of the corresponding text file and obtain an updated text file if the version indicators differ.

The text data for formulating communications may include acceptable parameter types for use in communicating with the remote service.

The text data for formulating communications may further comprise information on legitimate values for the parameter types.

The text data for formulating communications may further comprise acceptable operators for use with the parameter types. The acceptable operators may comprise boolean operators (for expressing logical relationships between fields), and comparison operators, such as equals, less than or equal to, etc. An important type of comparison operation is for comparing text strings, where the following types of criteria might be applied: wildcards, substring matching, case insensitive matching and fuzzy string matching.

The remote service may comprise a database of information, communications from the computer system comprising queries on the database of information, wherein results of the query are communicated to the computer system.

The remote service may comprise a World Wide Web server hosting a World Wide Web site on the Internet, the computer system being arranged to communicate with the World Wide Web site for communicating with the remote service.

The computer system may comprise a selected one of: a mobile telephone, a personal digital assistant, a personal computer, a digital video recorder, an intelligent household appliance or a decoder for a digital television system.

The text file may comprise an Extensible Markup Language file, the network address and text data comprising metadata fields within the Extensible Markup Language file.

According to another aspect of the present invention, there is provided a method of accessing a remote system from a computer system comprising the steps of:

accessing a text file at the computer system, the text file comprising a network address for communicating with the remote service and text data for formulating communications with the service;

processing the text file to formulate communications to the network address of the remote service in dependence on the text data for formulating communications with the service.

The method may further comprise the steps of:

generating a user interface including the input fields corresponding to the text data for formulating communications with the service;

accepting inputs to the input fields; and,

generating a communication from the accepted inputs to the network address in dependence on the text data for formulating communications with the service.

The method may further comprise the steps of:

maintaining a version indicator for the text file;

comparing a version indicator included in communications received from the remote service; and,

obtaining an updated text file if the version indicators differ.

Examples of the present invention will now be described in detail, by way of illustration only, and with reference to the accompanying drawings, in which:

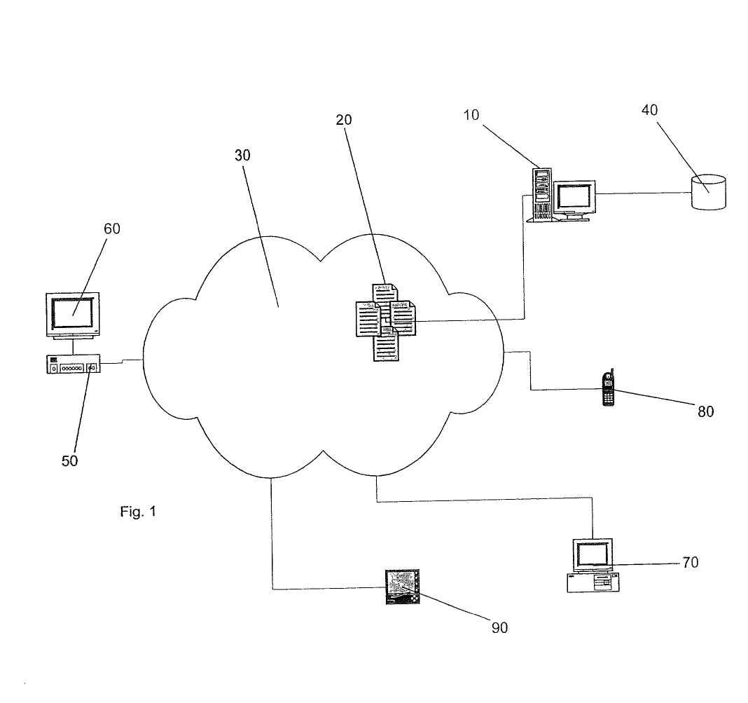

FIG. 1 is a schematic diagram of a computer system implementing a service access system according to the present invention;

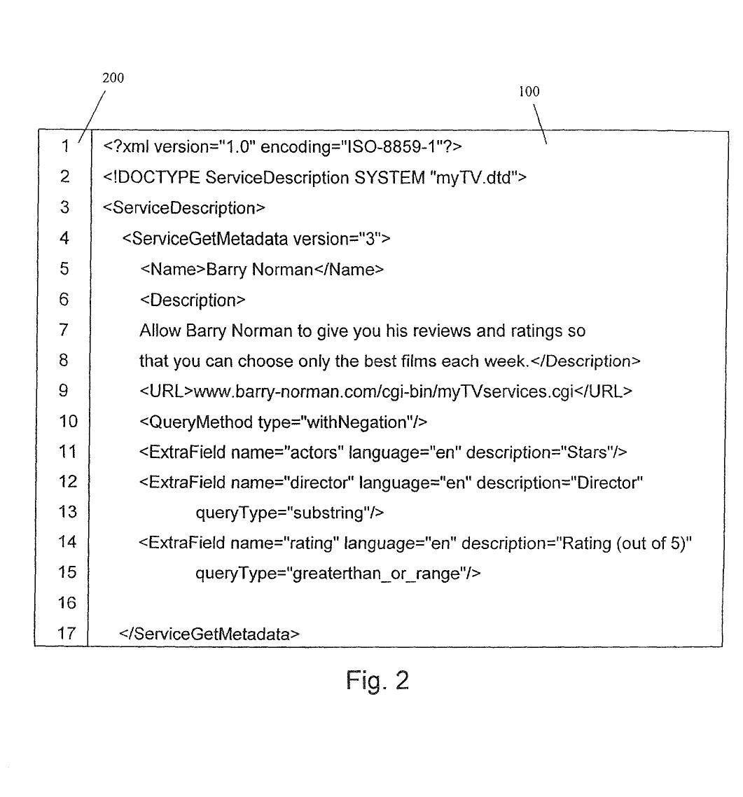

FIG. 2 is an example service definition metadata file for use in the service access system according to the present invention;

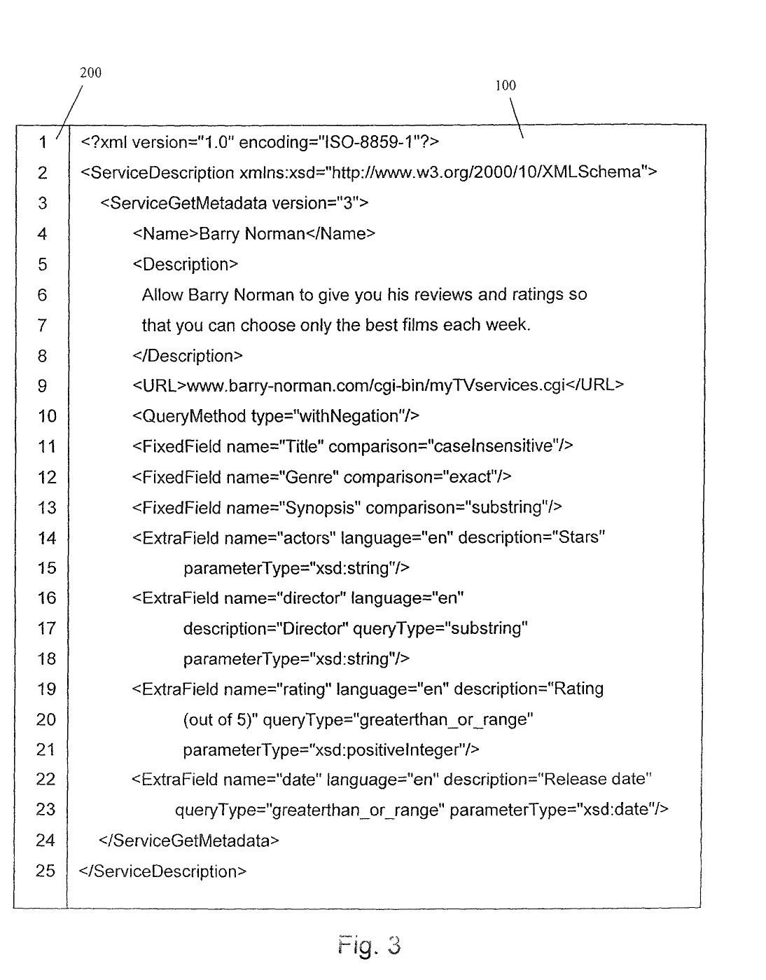

FIG. 3 is another example service definition metadata file for use in the service access system according to the present invention; and,

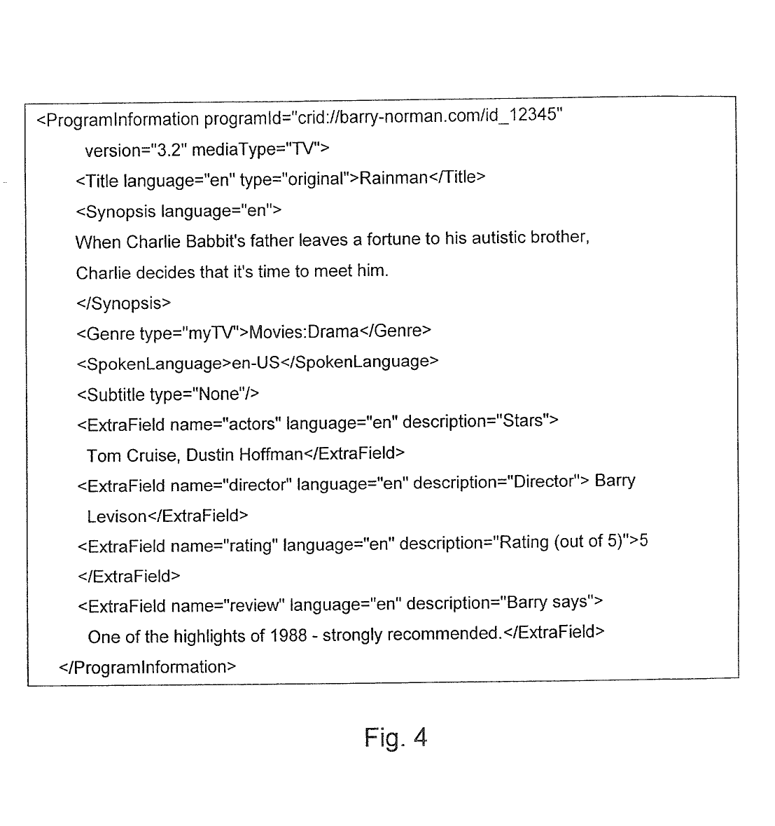

FIG. 4 is a response received from a service using the service access system of the present invention.

FIG. 1 is a schematic diagram of a computer system implementing a service access system according to the present invention.

A computer server 10 hosts a World Wide Web site 20 on the Internet 30. The World Wide Web site 20 offers access to a database 40 of information that can be searched using the World Wide Web site 20 over the Internet 30 via remote user terminals. The remote user terminals may be set-top-boxes 50 connected to television sets 60, PC's 70, mobile telephones 80, personal data assistants 90 or other computer based devices.

The user terminals have a standard instruction set which both they and the Web site 20 understand the semantics of. The user terminals also either include a copy of a service definition metadata file associated with the Web site 20 in a memory or are able to obtain an appropriate metadata file. In order to access the database 40 and query it, a user terminal accesses its copy of the file in conjunction with the standard instruction set.

As opposed to many existing client-server arrangements, the present invention does not use specifically written client software or embedded systems. Instead, the service description metadata file is an Extensible Markup Language (XML) file that contains information sufficient for a user terminal in combination with the standard instruction set to generate any necessary client system such as a user interface and to be able to formulate and submit requests to the server of a service.

The service definition file includes a description of the services it can be used to access along with data enabling the user terminal to form a communication to the service. The metadata file also includes a version number. The user terminal uses the data in the metadata file to generate a user interface to enable a user to query and interact with the service. Alternatively, if no user interaction is necessary, the data may merely be used to formulate a request to the service without the user terminal needing to refer to the user. An example, of such a request is a nightly download of television scheduling information that a set top box might make.

Once the user query or the request has been formulated using the contents of the metadata file, it is submitted to the service at a network address provided in the metadata file. Typically, the network address will be that of the Web site 20 on the Internet 30.

Upon receipt, the server 10 processes the request and takes the necessary action. The action may result in information being returned to the user terminal, new or updated applications being downloaded to the user terminal, data associated with the user or user terminal being updated at a remote location or some other action. For example, the results may simply be an indication as to the success of a request or may be information from a database that matches a submitted query.

In a specific example, the remote user terminal may be a so-called intelligent fridge (not shown) or other household device, in which case the database 40 may contain information on recipes, food products or be associated with a vendor from which the fridge can order food.

It will be appreciated that client-server arrangements are common in the art. However, client-server arrangements typically involve a specifically written client that is possibly embedded within the hardware or operating system of the client user terminal. If the database 40 is updated to include new fields or field types that can be searched, a conventional client requires corresponding updates to access or query the new fields or field types, perhaps even to continue accessing or querying known fields or field types.

However, in a service access system according to the present invention, each response includes a version number. The version number matches that of the current metadata file that should be used to formulate requests or queries to the service. If the service to be accessed changes, the version number will also be changed and will therefore not match that of the out of date metadata file at the user terminal receiving the response. Upon receipt of a response, the user terminal checks the version number of the response against that of its metadata file and downloads an updated metadata file from the server 10 if the versions do not match. In this manner, new functionality can be incorporated without user interaction or a full web browser.

FIG. 2 is an example service definition metadata file for use in the service access system of the present invention. In this example, the file allows a database of films to be searched by a user terminal. The line numbers 200 shown next to the metadata 100 of the metadata file are for illustration purposes only and are not normally included in metadata files.

The fields in lines 4 to 10 describe the service provided and the destination to which a user terminal should submit requests or queries. Line 4 defines the version of the metadata file for the service as “3”. Lines 5 to 8 provide a title (“Barry Norman” line 5) and a description (“Allow Barry Norman to give you his reviews and ratings so that you can choose only the best films each week.” lines 6 to 8) for the service that can be relayed to the user in the user interface.

In line 9, the network address for the service is specified as an Internet Uniform Resource Locator (URL) of “www.barry-norman.com/cgi-bin/myTVservices.cgi”.

Line 10 informs the user terminal of the types of queries that are acceptable by the service. In this case, the service allows queries “withNegation”, i.e. positive and negative query terms. Other query types include whether or not OR operators are accepted and whether or not precedence can be indicated in the query string using parentheses.

By implication that no exceptions to the standard instruction set are specified in the service definition file, the Web site 20 associated with the service definition file is assumed to accept any query comprised of instructions from the standard instruction set.

Extensions to services a user terminal does not understand the semantics of are provided in the form of extra fields. Such extensions may be new fields that can be searched but for which the operating system of the user terminal has no semantic understanding and therefore cannot support. The extensions are explicitly identified in the metadata file as extra fields (in the example of FIG. 2 by using the tag <ExtraField>) and include a descriptor field. Examples of the extra fields can be seen in lines 11, 12 and 14 of FIG. 2. The user terminal need not understand the effect or relevance of the extensions, it must merely be able to relay a provided descriptor to the user. The descriptor should provide enough information for the user to appreciate what the extension is and what it is used for. In this manner, a user can instruct the user terminal to incorporate or use the extension in a request or query, the user terminal relaying the extension to a server of a service that understands the extension without further interaction.

To submit a query or request, the user terminal formats the query for submission to the destination specified in the metadata file. For example, if the input for the Stars field was “Tom Cruise”, the Rating (out of 5) field was “5” and the genre field was “Drama”, the user terminal takes the network address from line 9 and formulates a query as follows:

http://www.barry-norman.com/cgi-bin/myTVservices.cgi?actors=Tom+Cruise&rating=5&Genre=drama

The query is then transmitted onto the Internet for delivery to the server of the service.

FIG. 3 is another example service definition metadata file for use in the service access system according to the present invention;

In the service definition file of FIG. 3, all applicable fields are declared, not just the extra fields as in the example of FIG. 2. Instructions from the standard instruction set that are supported are indicated in the file with a <FixedField>tag. The supported instructions merely serve to indicate to the user terminal that it can use that particular instruction or field from the standard instruction set. No further information is required for such instructions because they are already semantically understood by the user terminal.

FIG. 4 is a response received from the service to the query. The extra fields in the response are of the same format as those in the service definition file that held by the user terminal. The response is then used to generate a screen for display to the user. It will be seen that the version, “3.2”, stated in the response differs from that in the metadata file of FIG. 2. Upon detecting the difference, the user terminal transmits a blank query to the service in the form:

http://www.barry-norman.com/cgi-bin/myTVservices.cgi

The service understands this to be a request for the most up to date metadata file and transmits the file to the user terminal. Upon receipt of the file, the user terminal stores it in memory, replacing the existing service definition metadata file. By using this mechanism for retrieving the file, a device can guarantee being able to obtain a service description file of any service for which it has a URL.

A service definition file may include references to information on a number of different services. For example, a third party specialising in films could provide URLs on all the metadata services which allow the user to search for films, alternatively a television broadcaster's file may point to its services for gardening programmes, cooking programmes and films. In this way, the service description file facilitates the discovery of new services, as well as telling the device how to use the services. By following the URLs for each service, new service description files are downloaded and so on. i.e. the device can chain together the files and act as a spider.

Whilst the present invention has been described with reference to remote devices accessing Web based databases over the internet, it could equally be implemented over other networks where point to point communication is possible such as broadband, or digital cable television networks. Furthermore, whilst specific examples have been directed to querying remote databases, submitted requests could equally be used to trigger downloading of data and applications, requests for services, submission of data or any other client-server communication.

Although the specific examples have been shown using XML and CGI queries, other technologies could be equally used and would only require changes to the manner in which queries or requests are formulated and submitted.

1. A system for accessing a remote service from a computer system comprising a text file of data on the remote service comprising a network address for communicating with the remote service and text data for formulating communications with the service, wherein the computer system includes an interpretation system for processing the text file, the interpretation system formulating communications to the network address of the remote service in dependence on the text data for formulating communications with the service.

2. A system according to claim 1, wherein the interpretation system is arranged to generate a user interface for display on the computer system in dependence on the text data for formulating communications, the computer system being arranged to accept inputs to the user interface, the interpretation system using the inputs to formulate the communications.

3. A system according to claim 1, wherein the text file and data received from the remote service each include a version indicator, wherein the computer system is arranged to compare the version indicator of data received from the remote service with that of the corresponding text file and obtain an updated text file if the version indicators differ.

4. A system according to claim 1, wherein the text data for formulating communications includes acceptable parameter types for use in communicating with the remote service.

5. A system according to claim 4, wherein the text data for formulating communications further comprises information on legitimate values for the parameter types.

6. A system according to claim 4, wherein the text data for formulating communications further comprises acceptable operators for use with the parameter types.

7. A system according to claim 6, wherein the acceptable operators comprise selected ones of: boolean operators for expressing logical relationships between fields, comparison operators, comparison operators for text strings, wildcards, substring matching, case insensitive matching and fuzzy string matching.

8. A system according to claim 1, wherein the remote service comprises a database of information, communications from the computer system comprising queries on the database of information, wherein results of the query are communicated to the computer system.

9. A system according to claim 8, wherein the remote service comprises a World Wide Web server hosting a World Wide Web site on the Internet, the computer system being arranged to communicate with the World Wide Web site for communicating with the remote service.

10. A system according to claim 1, wherein the computer system comprises a selected one of: a mobile telephone, a personal digital assistant, a personal computer, a digital video recorder, an intelligent household appliance or a decoder for a digital television system.

11. A system according to claim 1, wherein the text file comprises an Extensible Markup Language file, the network address and text data comprising metadata fields within the Extensible Markup Language file.

12. A system according to claim 1, wherein the text file includes a network address for each of a plurality of remote services, the interpretation interpretation system being arranged upon request to obtain a further text file for the remote service from the network address.

13. A method of accessing a remote system from a computer system comprising the steps of:
accessing a text file at the computer system, the text file comprising a network address for communicating with the remote service and text data for formulating communications with the service;
processing the text file to formulate communications to the network address of the remote service in dependence on the text data for formulating communications with the service.

14. A method according to claim 13, further comprising the steps of:
generating a user interface including the input fields corresponding to the text data for formulating communications with the service;
accepting inputs to the input fields; and,
generating a communication from the accepted inputs to the network address in dependence on the text data for formulating communications with the service.

15. A method according to claim 13 or 14, further comprising the steps of:
maintaining a version indicator for the text file;
comparing a version indicator included in communications received from the remote service; and,
obtaining an updated text file if the version indicators differ.

16. A computer program comprising computer program code means for performing all the steps of any of claims 13 to 15 when the computer program is run on a computer.

17. A computer program according to claim 16 embodied on a computer readable medium.
